(19) United States
(12) Patent Application Publication
(10) Pub. No.: US 2008/0130736 A1
(43) Pub. Date: Jun. 5, 2008

(54) METHODS AND DEVICES FOR CODING AND DECODING IMAGES, TELECOMMUNICATIONS SYSTEM COMPRISING SUCH DEVICES AND COMPUTER PROGRAM IMPLEMENTING SUCH METHODS

(75) Inventors: Patrice Onno, Rennes (FR); Xavier Henocq, Melesse (FR); Felix Henry, Rennes (FR); Fabrice Le Leannec, Mouaze (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/772,973

(22) Filed: Jul. 3, 2007

(30) Foreign Application Priority Data
Jul. 4, 2006 (FR) 0652790

(51) Int. Cl. H04N 7/26; G06K 9/36

(52) U.S. Cl. 375/240.01; 382/232; 382/233; 375/E07.026

(57) ABSTRACT

The method of coding a digital image, comprising a step of coding in a format comprising a lower definition layer and at least one higher definition layer further comprises:
a step of determining at least one data rate and/or at least one distortion corresponding to a target definition between the lower definition and a higher definition and
a step of associating, with the result of the coding step, information representing at least one data rate and/or at least one distortion corresponding to a target definition.

The present invention concerns methods and devices for coding and decoding images, a telecommunications system comprising such devices and computer programs implementing such methods. It applies, in particular, to video coders and decoders.

The present invention aims to provide a simple solution linked in particular the functionality of spatial scalability of the future “SVC” standard (acronym for “Scalable Video Coding”). SVC is a new video coding standard in course of preparation which should be finalized in 2006. SVC is being developed by the “JVT” group (acronym for “Joint Video Team”), which includes experts in video compression of the “MPEG” group (acronym for “moving picture expert group”) of the ISO/IEC committee (acronym for “International Standardization Organization/international Electrotechnical Committee”) and the video experts of the ITU (acronym for “International Telecommunications Union”). SVC is based on the video compression techniques of the “MPEG4-AVC” standard (AVC is the acronym for “Advanced Video Coding”) also called “H.264” and seeks to extend it, in particular to give greater capacity of adaptation, termed “scalability”, of the video format. More particularly, this new video format will have the possibility of being decoded differently depending on what is possible for the decoder and the characteristics of the network.

Considering two video sequences to code of different size, a particular technique has been developed in the SVC standard to enable the video of greater size (higher layer) to be coded on the basis of the video of smaller size (lower layer), the aim being to predict, as well as is possible, the video of greater size on the basis of the video of smaller size.

For example, on the basis of a video of medium definition, of “SD” type (acronym for “Standard Definition”), of size 704×576 and frequency 60 Hz, with the SVC standard, it will be possible to code in a single bitstream, using two “layers”, the compressed data of the preceding SD sequence and those of a sequence in CIF format (acronym for “Common Intermediate Format”) of definition 352×288 and frequency 60 Hz. To decode the CIF definition, the decoder will only decode part of the information coded in the bitstream. On the other hand, it will have to decode the entirety of the bitstream to reproduce the SD version.

The example given above illustrates the functionality of spatial scalability, that is to say the possibility of extracting videos, on the basis of a single bitstream, of which the definition of the images (also known by the term resolution) is different. In the above example, the ratio of definitions between the two images of the two SD and CIF sequences is two in each dimension (horizontal and vertical). It should be noted that the forthcoming standard is not limited to that value of two, which is nevertheless the most common. It is planned for it to be possible to have any ratio of definition of the images between the two layers considered.

It is to be noted that, for given image definitions and for a given frame rate, it will be possible to decode a video by selecting the desired quality according to the capacity of the network. This illustrates the three main axes of scalability provided by SVC which are spatial, temporal and quality scalability.

In the context of the SVC standard, a proposal has been made (see the article “AHG Report on Spatial Scalability Resampling” of the “Joint Draft 6” arising from the 19^{th} proceedings of the “Joint Video Team (JVT) of ISO/IEC MPEG & ITU-T VCEG (ISO/IEC TC1/SC29/WG11 and ITU-T SG16Q.6)”, in Geneva, Switzerland, on Mar. 31-Apr. 7, 2006 and available for example at http://ftp3.itu.ch/av-arcj§kvt-site/2006 04 Geneva/JVT-S006.doc) for a tool for achieving this spatial scalability function which is called Extended Spatial Scalability (of which the acronym is “ESS”). This tool describes how to make the predictions of the higher layer (also termed “enhancement layer”) on the basis of the lower layer (also termed “base layer”) whatever the ratio of the definitions of the images between those two layers. These predictions concern both the inter-layer motion prediction, the inter-layer texture prediction and the inter-layer residual prediction.

It is rather easy to predict the macroblocks of a higher layer on the basis of the lower layer when the ratio of definitions between the blocks are integer. In particular, a definition ratio of two makes the four macroblocks of the higher layer perfectly coincide with one macroblock of the lower layer.

For fractional definition ratio values (for example 3/2, 4/3 or 5/3), the non-match of the macroblocks of the lower layer with those of the higher layer leads to a prediction that is more complicated to implement. This matching becomes difficult when the ratios have fractional values of which the denominator is high (for example for a 17/11 horizontal ratio which makes 17 blocks of the higher layer match with 11 blocks of the lower layer: the horizontal block boundaries only match every 17 blocks for the higher layer with the block boundaries every 11 blocks in the lower layer).

The solution proposed by ESS makes it possible, for the three aforementioned prediction modes, to match the blocks and macroblocks of the lower layer with those of the higher layer using a complex algorithm described in the specification of the standard. This algorithm makes it possible to predict both the motion vectors and texture. However, this solution is complex and highly resource-consuming.

The current specification of the SVC standard makes it possible to include, for example, a lower layer and a higher layer that have any definition ratio between them. However, only the two definitions chosen by the user at the coder are decodable by the decoder. The same coded video cannot thus be decoded and optimized for other definitions than those anticipated on coding.

The present invention aims to remedy these drawbacks.

To that end, according to a first aspect, the present invention concerns a method of coding a digital image, comprising a step of coding in a format comprising a lower definition layer and at least one higher definition layer, characterized in that it further comprises:

a step of determining at least one data rate and/or at least one distortion corresponding to a target definition between the lower definition and a higher definition,

a step of associating, with the result of the coding step, information representing at least one data rate and/or at least one distortion corresponding to a target definition.

Thus, for the implementation of the present invention, at the coder, provision is made for the coding of images with target definitions for which there is provided, at the decoder, information on the data rate necessary for the decoding, in order for the decoder to be able to make choices, for a display definition, even if different from each target resolution. The implementation of the present invention thus makes it possible to achieve spatial scalability whatever the display definition strictly included, in each dimension of the image, between the lower definition and the highest definition. The implementation of the present invention, at the coder, makes it possible to achieve any display definition by a downsampling operation performed at the decoder on the decoded images.

It is to be noted that, within the meaning of the present invention, the term image covers not only complete images but also the parts of images, for example, the blocks or macroblocks used to code or decode an image. Thus, the present invention may be implemented for only a portion of the blocks constituting an image.

The spatial scalability is thus obtained without recourse to a complex algorithm, to take into account definitions of the image to reproduce on decoding, for matching blocks and macroblocks of the lower layer with those of the higher layer.

The present invention thus has, in particular, the following advantages:

great simplicity of implementation,

better performance than the prior art, in terms of compression and

the possibility of introducing several target resolutions in a higher layer.

The applications of the invention aim to provide a good rate-distortion ratio at the decoder, whatever the case. For example, on the basis of a high definition video (for example 1920×1080), the implementation of the present invention makes it possible, for display on the screen of a personal digital assistant or of a mobile telephone, to decode smaller spatial versions which are better adapted to the resources and the screen definition of the decoding device.

According to particular features, during the associating step, association is made with the result of the coding step of information representing at least one target definition and at least one said rate corresponding to said target definition, at one physical quantity at least.

According to particular features, said physical quantity is a decoded image distortion produced by downsampling a decoded higher layer, to obtain the image having the target definition.

By virtue of each of these provisions, the decoder can take into account at least one parameter other than only the rate, for example the distortion of the decoded image, to determine the decoding conditions, for example on the basis of the display definition used.

According to particular features, during the determining step, determination is made, for at least one target definition, of a plurality of rates corresponding to a plurality of decoded image distortions and, during the associating step, an item of information representing said rates and said distortions is associated with the result of the coding step.

According to particular features, during the determining step, determination is made, for at least one target definition, of the parameter values of a decoded image rate model on the basis of a distortion of said decoded image, and, during the associating step, an item of information representing said parameter values is associated with the result of the coding step.

According to particular features, during the determining step, determination is made, for at least one target definition, of the rate-distortion pairs and, during the associating step, an item of information representing said pairs is associated with the result of the coding step.

By virtue of each of these provisions, the decoder can take into account the distortion of the decoded image to choose the rate implemented on decoding, for example on the basis of the display definition.

According to particular features, the determining step comprises a step of selecting at least one said target definition. For example, the selection may be made by a user.

By virtue of each of these provisions, at least one target definition may be chosen, for example on the basis of a transmission channel, of a broadcast secure and/or of a prior knowledge of the display definitions used by recipients of the images.

According to particular features, during the coding step, SVC scalable video coding is implemented.

According to particular features, during the coding step, for at least one higher layer, CGS (acronym for “Coarse Grain Scalability”) is implemented.

According to particular features, during the coding step, for at least one higher layer, FGS fine grain scalability is implemented.

By virtue of each of these provisions, the implementation of the present invention is a simple alternative to a tool already existing in the future SVC standard, which provides a spatial scalability functionality. Furthermore, the implementation of the present invention provides better results than those of the SVC standard's tool: the compression rate is higher for an equivalent quality.

Furthermore, the implementation of the present invention makes it possible to introduce several factors of definition into the same higher layer. This is because, by using the FGS (acronym for “fine grain scalability”) tool in SVC, it is possible to decode all or a part of the FGS layer. A simple item of information concerning the association made between the rates and the target definitions then makes it possible to decode the data necessary for reproducing the intended definition.

According to particular features, during the coding step, each higher definition is an integer multiple of the lower definition.

According to particular features, during the coding step, the higher definition is a power of two times the lower definition, in each dimension of the image.

This is because the inventors have determined that this ratio is favorable, in terms of consumption of resources and in terms of image quality, both on coding and on decoding.

According to particular features, during the coding step, at least two higher layers are coded, the ratio between the image definitions of the higher layers being, in each dimension of the image, an integer number, at least one of the higher layers being coded by using another higher layer.

Thus, to obtain, on decoding, images having a definition intermediate between the definitions of the higher layers, the highest definition layer is used and downsampling is carried out. The plurality of higher layers enables greater scalability for the different viewing screen formats, including those qualified as “high definition” and those of portable terminals of low definition, while limiting losses in image quality due to the difficulties of prediction between images of definitions that are too different.

The coding method as succinctly set forth above is particularly adapted to the transmission of signals representing coded images and information representing each data rate corresponding to a target definition, in parallel or further to the image coding step.

By virtue of these provisions, the advantages of streaming are benefited from.

According to particular features, the method as succinctly set forth above further comprises a step of associating, with the result of the coding step, an item of information representing the necessity, on decoding, of performing a downsampling step.

According to particular features, the method as succinctly set forth above further comprises a step of determining a number of higher layers to code, on the basis of at least one target definition.

By virtue of these provisions, it is possible to automatically adapt the number of higher layers to code to the highest target definition, in particular when the ratio of definitions between the higher layers is predetermined, for example two.

According to particular features, the method as succinctly set forth above further comprises a step of determining an integer ratio between the definitions of two layers, on the basis of at least one target definition.

By virtue of these provisions, it is possible to determine the higher definition in order for it to be, both a multiple of the definition lower or of another higher definition and higher than the highest target definition. The advantages of implementing integer ratios are thus benefited from, in terms of simplicity of calculation, of consumption of resources and of decoded image quality.

According to a second aspect, the present invention concerns a method of decoding a digital image coded in a format comprising at least one lower definition layer and at least one higher definition layer, to form an image having a display definition, which comprises:

a step of obtaining an item of information representing at least one data rate and/or at least one distortion, for at least one target definition, between the lower definition and a higher definition,

a step of determining a decoding rate, on the basis of the display definition and said item of information representing at least one data rate and/or at least one distortion, for a target definition,

a step of decoding a set of data of a higher layer of higher definition than the display definition, said set of data corresponding to the decoding rate determined during the determining step, to provide a decoded image having said higher definition,

a step of downsampling said decoded image to provide the image having said display definition.

Thus, in a manner of low complexity, the decoding method according to the invention makes it possible to obtain decoded images that have a different definition to that of the higher layer, having a predefined quality. In particular, by virtue of the invention, it suffices to decode only a portion of the coded data to obtain an intended quality and definition since in the received stream consideration is limited to the data of quality and definition immediately above the intended quality and definition.

According to particular features, during the obtainment step, information is obtained representing at least one rate corresponding to said target definition and to a decoded image distortion.

According to particular features, during the obtainment step, for at least one target definition, there is obtained a plurality of rates corresponding to a plurality of decoded image distortions.

According to particular features, during the obtainment step, for at one least one target definition, parameter values are obtained of a decoded image rate model on the basis of a distortion of said decoded image.

According to particular features, during the obtainment step, for at least one target definition, rate-distortion pairs are obtained.

According to particular features, the decoding method as succinctly set forth above comprises a step of selection, by a user, of said display definition.

By virtue of the method of the invention, it is possible to decode images at different definitions while preserving the simplicity of implementation.

According to particular features, the decoding method as set forth succinctly above further comprises:

a step of determining the display definition, during which the display definition is determined as being equal to that of a display screen and

a display step, during which the downsampled image having said display definition is displayed on said display screen.

According to particular features, during the decoding step, SVC scalable video decoding is implemented.

According to particular features, during the decoding step, said higher layer is decoded by implementing CGS coarse grain scalability.

According to particular features, during the decoding step, the higher layer is decoded by implementing FGS fine grain scalability.

According to a third aspect, the present invention concerns a device for coding a digital image, comprising a means for coding in a format comprising a lower definition layer and at least one higher definition layer, which further comprises:

a means for determining at least one data rate and/or at least one distortion corresponding to a target definition between the lower definition and a higher definition and

a means for associating, with the result of the coding, information representing at least one data rate and/or at least one distortion corresponding to a target definition.

According to particular features, the associating means is adapted to associate information representing at least one target definition and at least one said rate corresponding to said target definition, at one physical quantity at least, with the result of the coding step.

According to particular features, said physical quantity is a decoded image distortion produced by downsampling a decoded higher layer, to obtain the image having the target definition.

According to particular features, the determining means is adapted to determine, for at least one target definition, a plurality of rates corresponding to a plurality of decoded image distortions and the associating means is adapted to associate an item of information representing said rates and said distortions with the result of the coding.

According to particular features, the determining means is adapted to determine, for at least one target definition, parameter values of a decoded image rate model on the basis of a distortion of said decoded image, and the associating means is adapted to associate an item of information representing said parameter values with the result of the coding.

According to particular features, the determining means is adapted to determine, for at least one target definition, rate-distortion pairs and the associating means is adapted to associate an item of information representing said pairs with the result of the coding.

According to particular features, the determining means comprises a means for selecting at least one said target definition.

According to particular features, the selecting means is adapted for a user to select at least one said target definition.

According to particular features, the coding means implements SVC scalable video coding.

According to particular features, the coding means implements, for at least one higher layer, CGS coarse grain scalability.

According to particular features, the coding means implements, for at least one higher layer, FGS fine grain scalability.

According to particular features, the coding means is adapted for each higher definition to be an integer multiple of the lower definition.

According to particular features, the coding means is adapted for the higher definition to be a power of two times the lower definition, in each dimension of the image.

According to particular features, the coding means is adapted to code at least two higher layers, the ratio between the image definitions of the higher layers being, in each dimension of the image, an integer number, at least one of the higher layers being coded by using another higher layer.

According to particular features, the coding device as succinctly set forth above comprises a means for transmitting signals representing coded images and information representing each data rate corresponding to a target definition, parallel to the coding performed by the image coding means.

According to particular features, the coding device as succinctly set forth above further comprises a means for associating with the result of the coding, an item of information representing the necessity, on decoding, of using a downsampling means.

According to particular features, the coding device as succinctly set forth above further comprises a means for determining a number of higher layers to code, on the basis of at least one target definition.

According to particular features, the coding device as succinctly set forth above further comprises a means for determining an integer ratio between the definitions of the two layers, on the basis of at least one target definition.

According to a fourth aspect, the present invention concerns a device for decoding a digital image coded in a format comprising at least one lower definition layer and at least one higher definition layer, to form an image having a display definition, characterized in that it comprises:

a means for obtaining an item of information representing at least one data rate and/or at least one distortion, for at least one target definition, between the lower definition and a higher definition,

a means for determining a decoding rate, on the basis of the display definition and said item of information representing at least one data rate and/or at least one distortion, for a target definition,

a means for decoding a set of data of a higher layer of higher definition than the display definition, said set of data corresponding to the decoding rate determined by the determining means, to provide at least one decoded image having said higher definition,

a means for downsampling said decoded image to provide an image having said display definition.

According to particular features, the obtaining means is adapted to obtain information representing at least one rate corresponding to said target definition and to a decoded image distortion.

According to particular features, the obtaining means is adapted to obtain, for at least one target definition, a plurality of rates corresponding to a plurality of decoded image distortions.

According to particular features, the obtaining means is adapted to obtain, for at one least one target definition, parameter values of a decoded image rate model on the basis of a distortion of said decoded image.

According to particular features, the obtaining means is adapted to obtain, for at least one target definition, rate-distortion pairs.

According to particular features, the decoding device as succinctly set forth above comprises a means for selection, by a user, of said display definition.

According to particular features, the decoding device as set forth succinctly above further comprises:

a means for determining the display definition as equal to that of a display screen and

a display means adapted to display the downsampled image having said display definition on said display screen.

According to particular features, the decoding means implements SVC scalable video decoding.

According to particular features, the decoding means is adapted to decode said higher layer by implementing CGS coarse grain scalability.

According to particular features, the decoding means is adapted to decode the higher layer by implementing FGS fine grain scalability.

According to a fifth aspect, the present invention concerns a telecommunications system comprising a plurality of terminal devices connected via a telecommunications network, characterized in that it comprises at least one terminal device equipped with a coding device as succinctly set forth above and at least one terminal device equipped with a decoding device as succinctly set forth above.

According to a sixth aspect, the present invention concerns a computer program loadable into a computer system, said program containing instructions enabling the implementation of the coding method as succinctly set forth above, when that program is loaded and executed by a computer system.

According to a seventh aspect, the present invention concerns a computer program loadable into a computer system, said program containing instructions enabling the implementation of the decoding method as succinctly set forth above, when that program is loaded and executed by a computer system.

According to an eighth aspect, the present invention concerns an information carrier readable by a computer or a microprocessor, removable or not, storing instructions of a computer program, characterized in that it enables the implementation of the coding method as succinctly set forth above.

According to a ninth aspect, the present invention concerns an information carrier readable by a computer or a microprocessor, removable or not, storing instructions of a computer program, characterized in that it enables the implementation of the decoding method as succinctly set forth above.

As the advantages, objectives and characteristics of this coding device, of this decoding device, of this telecommunications system, of these computer programs, and of these information carriers are similar to those of the filtering method, as succinctly set forth above, they are not repeated here.

Other advantages, objectives and features of the present invention will emerge from the following description, given, with an explanatory purpose that is in no way limiting, with respect to the accompanying drawings in which:

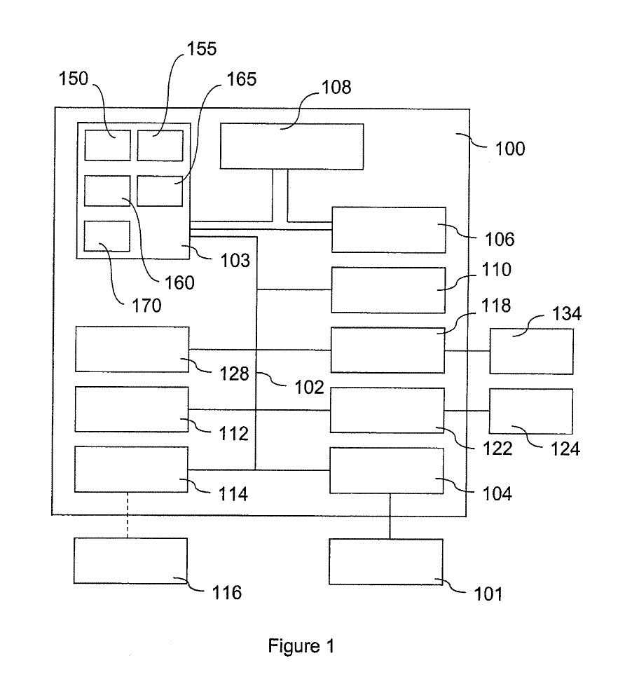

FIG. 1 represents, in the form of a block diagram, a particular embodiment of the coding device and of the decoding device object of the present invention;

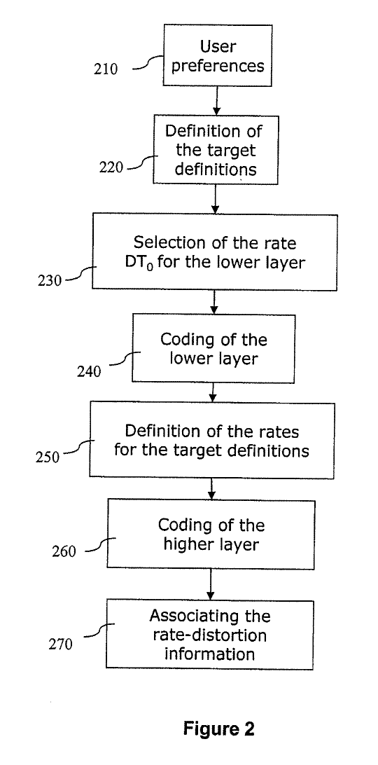

FIG. 2 is a representation, in the form of a logigram, of the steps implemented in a particular embodiment of the coding method object of the present invention;

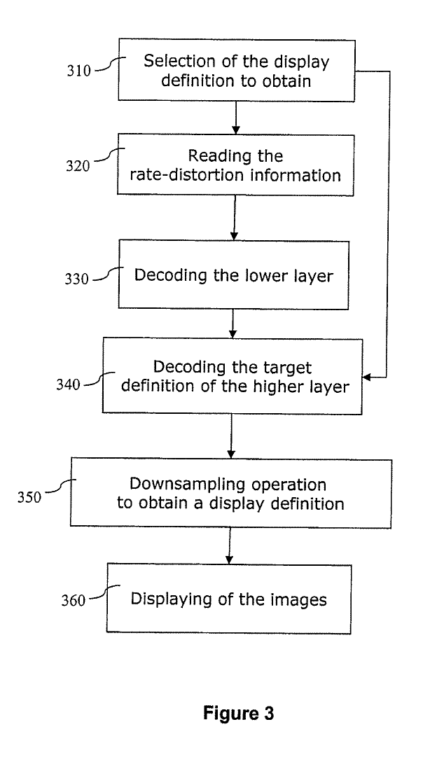

FIG. 3 is a representation, in the form of a logigram, of the steps implemented in a particular embodiment of the decoding method object of the present invention, and

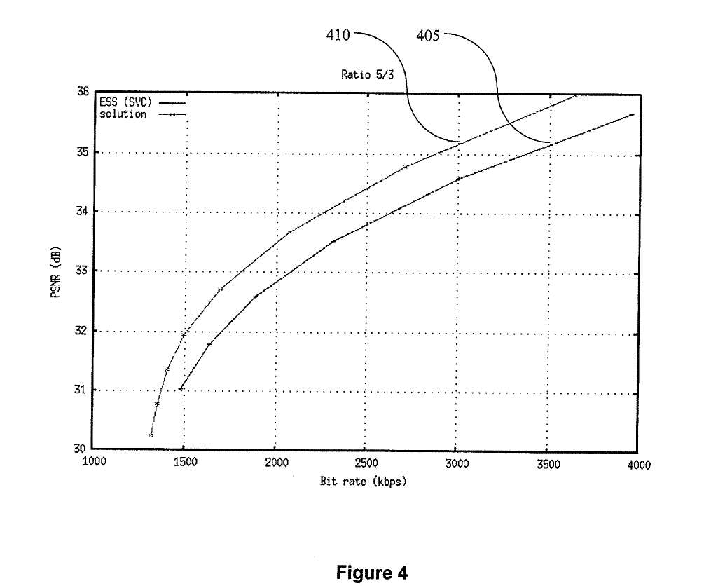

FIG. 4 represents, in the form of curves, a comparison of quality obtained with and without implementation of the present invention.

It should be recalled that, within the meaning of the present invention, the term image covers not only complete images but also the parts of images, for example, the blocks or macroblocks used to code or decode an image. Thus, the present invention may be implemented for only a portion of the blocks constituting an image.

The means described below, with respect to FIG. 1, concern a coding device and a decoding device object of the present invention. In telecommunications systems object of the present invention, a plurality of terminals devices are connected, through a telecommunications network, at least two of these terminals devices comprising a coding device as described with respect to FIG. 1 and a decoding device as described with respect to FIG. 1.

In embodiments, a communication network of “streaming” or continuous stream broadcasting type, is set up between the decoder and the coder.

FIG. 1 shows a device 100 object of the present invention for coding and/or decoding, and different peripherals adapted to implement each aspect of the present invention. In the embodiment illustrated in FIG. 1, the device 100 is a micro-computer of known type connected, in the case of the coder, through a graphics card 104, to a means for acquisition or storage of images 101, for example a digital moving image camera or a scanner, adapted to provide moving image information to code and transmit.

The device 100 comprises a communication interface 118 connected to a network 134 able to transmit, as input, digital data to code or decode and, as output, data coded or decoded by the device. The device 100 also comprises a storage means 112, for example a hard disk, and a drive 114 for a diskette 116. The diskette 116 and the storage means 112 may contain data to code or to decode, coded or decoded data and a computer program adapted to implement the method of coding or decoding object of the present invention.

According to a variant, the program enabling the device to implement the present invention is stored in ROM (acronym for Read Only Memory) 106. In another variant, the program is received via the communication network 134 before being stored.

The device 100 is, optionally, connected to a microphone 124 via an input/output card 122. This same device 100 has a screen 128 for viewing the data to be to coded or decoded data or for serving as an interface with the user for parameterizing certain operating modes of the device 100, using a keyboard 110 and/or a mouse for example.

A CPU (central processing unit) 103 executes the instructions of the computer program and of programs necessary for its operation, for example an operating system. On powering up of the device 100, the programs stored in a non-volatile memory, for example the read only memory 106, the hard disk 112 or the diskette 116, are transferred into a random access memory RAM 108, which will then contain the executable code of the program object of the present invention as well as registers for storing the variables necessary for its implementation.

Naturally, the diskette 116 may be replaced by any type of removable information carrier, such as a compact disc, card or key memory. In more general terms, an information storage means, which can be read by a computer or microprocessor, integrated or not into the device, and which may possibly be removable, stores a program object of the present invention. A communication bus 102 affords communication between the different elements included in the device 100 or connected to it. The representation, in FIG. 1, of the bus 102 is non-limiting and in particular the central processing unit 103 unit may communicate instructions to any element of the device 100 directly or by means of another element of the device 100.

The device described here may implement all or part of the processing operations described with respect to FIGS. 2 and 3 for implementing each method object of the present invention.

By the execution of the program implementing the method object of the present invention, the central processing unit 103 constitutes the following means:

a means for determining at least one data rate and/or at least one distortion corresponding to a target definition between the lower definition and a higher definition,

a means for associating, with the result of the coding, information representing at least one data rate and/or at least one distortion corresponding to a target definition,

when the device operates in coding mode,

a means for obtaining an item of information representing at least one data rate and/or at least one distortion, for at least one target definition, between the lower definition and a higher definition,

a means for determining a decoding rate, on the basis of the display definition and said item of information representing at least one data rate and/or at least one distortion, for a target definition,

a means for decoding a set of data of a higher layer of higher definition than the display definition, said set of data corresponding to the decoding rate determined by the determining means, to provide at least one decoded image having said higher definition,

a means for downsampling said decoded image to provide an image having said display definition,

when the device operates in decoding mode.

It is to be recalled that, in the future SVC standard, for example, on the basis of a video sequence of 560×480 format originally composed of 60 images per second, it is possible to code (and in turn to decode) a lower spatial definition of which the definition is, for example, equal to 336×288. The ratio between these two definitions, here 5/3, is chosen by the user who makes the videos available to the recipients, at the coder, and may be any particular ratio according to the application concerned.

In the same way, it is possible to code (and subsequently decode), for the same spatial definition (560×480), different diadic temporal versions: 60 Hz, 30 Hz, 15 Hz. The number of versions is also chosen by the user at the time of coding.

Finally, for each image of the illustrated sequences, the future SVC standard makes it possible to attribute a variable rate to each image and thus to provide scalability in terms of quality.

The techniques used in SVC thus make it possible to combine the spatial, temporal and qualitative aspects to provide, for example, a 336×288 video at 15 Hz having a low quality.

Of course, the concept of spatial scalability is used in relation to image receiver definitions commonly used on viewing videos and which are not multiples of 2. It is to be noted that ratios between the definitions may be different for the height and the width.

As set forth above, the present invention is directed, in particular, to providing coding and decoding methods and devices enabling spatial adaptation, in a simple way, providing better image quality than the prior art, compatible with tools of the SVC standard and avoiding the selection of the definition at the coder. The implementation of the present invention also makes it possible to decode the images with different definitions to those chosen on coding, for example to display them, successively, on a computer screen, on a high definition television, and on a screen of a mobile telephone or personal digital assistant screen.

FIG. 2 represents different steps carried out at the coder, for the implementation of a particular embodiment of the coding method object of the present invention and FIG. 3 different steps carried out at the decoder, for the implementation of a particular embodiment of the decoding method object of the present invention.

In the example chosen for the description of FIGS. 2 and 3, consideration is limited, in the aim of simplicity, to the coding of a lower layer and of a single higher layer. However, in accordance with the invention, a plurality of higher layers may be coded, each higher layer preferably being coded by using, for the prediction, the layer immediately below which may be the base layer or another higher layer.

In particular embodiments of the present invention, the number of higher layers is automatically determined on the basis of the definitions intended by the creator. For example, if the definition ratios are 4/3, 5/3 and 8/3 and at the coder a ratio of two is used between the definitions of the successive layers, the ratios of 4/3 and 5/3 (of which the value is between 1 and 2) will be achieved by the first higher layer and the last ratio (8/3) (of which the value is between 2 and 4) will be achieved by the second higher layer.

In the example chosen for the description of FIGS. 2 and 3, consideration is limited, in the aim of simplicity, to the definition ratios between two coded layers equal to two. However, in accordance with the invention, the definition ratios between two successive layers may be integer numbers, and preferably, powers of two.

In particular embodiments of the present invention, the ratio, which is integer, of the definitions between the layers is automatically determined, on the basis of the definitions intended by the creator.

For example, if the definition ratios are 4/3 and 5/3 (values between 1 and 2), the ratio of the chosen definitions is preferably two.

For example, if the highest definition ratio is the ratio 8/3 and, at the coder, only a single higher layer is used, the ratio of the definitions chosen will preferably be three or four.

In the example chosen for the description of FIGS. 2 and 3, consideration is limited, for simplicity, to coding of SVC type. However, the present invention applies to any coding implementing a plurality of layers for representing images of different definitions, at least one of those layers being coded using another layer.

In the particular embodiment illustrated in FIGS. 2 and 3, on coding, an image definition of 336×288 is chosen for the lower layer, and of 672×576 for the higher layer.

During a step 210, the user who makes the video available to recipients attributes a value to at least one coding parameter specific to SVC such as the coding mode, which may take the values CGS or FGS, the inter-layer prediction mode, the motion estimation parameters (for example search space, precision of the estimation, etc.), and the number of images in a Group of Pictures. It is noted that the possible functions and values of these different parameters are set forth in the public specification of the future SVC standard. According to another embodiment, these values may also be defined by default, without action by the user. They are for example stored on the apparatus which implements the coding.

During a step 220, the user selects the ratios of definitions which he desires to make available for the higher layer, with respect to horizontal and vertical definitions of the lower layer. These ratios correspond to the horizontal and vertical definitions for display at the decoder, it being understood that the implementation of the present invention enables images having other definitions to be displayed. According to an alternative embodiment, the ratios may be determined without action by the user, according to the applications concerned.

In other words, these ratios correspond to several types of screen definition. For example, for the definition ratios RR₁=4/3, RR₂=3/2 and RR₃=5/3, the definitions (rounded to the nearest integer) of the images reproduced after decoding and downsampling in accordance with the present invention will respectively be 448×384 for RR₁, 504×432 for RR₂ and 560×480 for RR₃.

It is noted that the decoding definitions may have different ratios for the two dimensions, horizontal and vertical, of the image. Thus, between two successive layers, it is possible to have a ratio of horizontal definitions of 4/3 and a ratio of vertical definitions of 5/3.

Next, during a step 230, selection of the maximum rate DT₀ is made for the lower layer, in a manner known per se.

During a step 240, the video sequence corresponding to the lower layer is coded with the rate DT₀.

During a step 250, at least one rate is associated with each definition selected at step 220. This step of associating the rates with the definitions may, in variants of the present invention, be made using at least two possible methods.

In a first case, operations of coding, decoding and downsampling are performed in order to precisely know, for a given definition, the distortions obtained for a given rate. Thus, a table comprising several rate-distortion pairs may be constructed for each of the selected definitions. For example, for three particular definition ratios RR1, RR2 and RR3, the tables are given below:

Table for the definition ratio RR1:
Corresponding image size 448 × 384

| | Rate | Distortion |
|---|---|---|
| | (Kbps) | (PSNR in dB) |
| 1 | 1500 | 31.94 |
| 2 | 2000 | 33.50 |
| 3 | 2500 | 34.40 |
| 4 | 3000 | 35.17 |
| 5 | 3500 | 38.83 |
| . . . | | |

Table for the definition ratio RR2:
Corresponding image size 504 × 432

| | Rate | Distortion |
|---|---|---|
| | (Kbps) | (PSNR in dB) |
| 1 | 1500 | 31.21 |
| 2 | 2000 | 32.82 |
| 3 | 2500 | 33.61 |
| 4 | 3000 | 34.45 |
| 5 | 3500 | 35.11 |
| . . . | | |

Table for the definition ratio RR3:
Corresponding image size 560 × 480

| | Rate | Distortion |
|---|---|---|
| | (Kbps) | (PSNR in dB) |
| 1 | 1500 | 30.51 |
| 2 | 2000 | 32.21 |
| 3 | 2500 | 33.31 |
| 4 | 3000 | 34.05 |
| 5 | 3500 | 34.61 |
| . . . | | |

In a second case, parameter modeling of the rate distortion curve of the different target definitions is made, for example by extrapolating the rate distortion curve of the lower layer. For example, a simple parameter model of type DTᵢ=Ai·exp(Bᵢ·DSᵢ) is used to model the rate DTᵢ of the definition i according to the distortion (squared error) DSᵢ on the basis of two real numbers Aᵢ and Bᵢ that are determined in a manner known per se, on the basis of data that are known or extrapolated, for example, those given in the above tables. In other examples, more complex parameter models are used comprising more parameters well known by the person skilled in the art. There are also several methods known to the person skilled in the art for rapidly adjusting the parameters of such a model.

In accordance with one aspect of the present invention, the coder provides the decoder with information representing at least one different definition/rate/distortion triple in order for the decoder to be able to determine at least one operating parameter, for example rate depending on the intended definition and on the permitted distortion or definition for a predetermined rate and distortion.

For example, the rate-distortion curves or the modeling thereof are provided, by the coder, to the decoder in order to enable the decoder to determine the qualities of the images which will be obtained for a given rate and selected definition. For example on the basis of the above tables the user knows that if he decodes the higher layer (of initial definition 672×576) with a rate of 2500 Kbit/s he will obtain a quality of 34.40 dB for the definition 448×384. On the other hand, for a higher definition (for example for the definition ratio RR2 corresponding to an image size of 504×432), and for the same rate of 2500 Kbit/s the quality will drop and will be situated at 33.61 dB. These representations of distortion according to rate thus make it possible to adapt or optimize the partial decoding of the higher layer to be carried out according to the needs of the user and of the decoding device.

According to another example, if a similar quality is intended for the different definitions (for example around 34.4 dB), the rate-distortion data show that, for the RR1 definition, it is necessary to reach a rate of 2500 Kbit/s whereas it will be necessary to decode a rate of 3000 Kbit/s for the RR2 definition.

During a step 260, the coding of the higher layer is carried out. According to the mode chosen in step 210, CGS or FGS, the coding of the higher layer is carried out in one of the following ways:

if the FGS mode has been chosen, the higher layer may be unique and the maximum rate DT₃, corresponding to the maximum rate necessary for obtaining a quality intended for the resolution RR3, is used as maximum rate of the higher layer. Since the FGS layer is divisible at any location, the three target definitions cited by way of example above are included in a single higher layer.

if the CGS mode has been chosen, the higher layer will be represented by as many physical layers as necessary according to the choice of the user. This is because the implementation of a single physical layer only makes it possible to code a single point of the rate-distortion curve of the different definitions chosen. On the other hand, by using, for example, five physical layers and by respecting the rates of 1500, 2000, 2500, 3000, and 3500 Kbit/s, the qualities presented in the above tables can precisely be achieved. In this case, the construction of the CGS layers perfectly corresponds with the forecast rate points. It is to be recalled that the CGS layers are complementary and are coded incrementally: the second layer contains an increment of coded data with respect to the first layer.

It is to be noted that the steps of coding the lower layer and the higher layer 240 and 260 are carried out alternately on a Group of Pictures (of which the acronym is GOP). This is because, after having compressed a Group Of Pictures in the lower layer, the coding of the higher layer for that same GOP is carried out (this concept of GOP could be introduced in relation to step 210). Next, a GOP for the lower layer is recommenced with, and so forth.

During a step 270, with the coded information, representing images, association is made of an item of information representing at least one data rate and/or at least one distortion corresponding to a target definition. This item of information in fact represents the necessity, on decoding, of performing a downsampling step to reproduce the intended definitions.

This item of information, to indicate to the decoder that it must perform the downsampling, may be signaled in different ways:

it may be indicated in the syntax of the decoder and is interpreted by the decoder which must perform downsampling: this is a mandatory function of the decoder;

it is indicated by via SEI messages (acronym for “Supplemental Enhancement Information”) as indicated below: it is then a decoding option;

it is indicated by another means, only a proprietary decoder is able to interpret this information (and thus implement the present invention).

Preferably, during a step 270, with the coded information, representing images, association is also made of an item of information representing the three intended definitions in order for the decoder to determine the coded data for each definition. These items of information for each definition are either rate-distortion pairs, or the modeling parameters (Ai, Bi).

In particular embodiments, during step 270, to transmit the information to the decoder, a message is used known by the name “SEI” (acronym for “Supplemental Enhancement Information”), specific to the implementation of the present invention. Different SEI messages are already described in section D of the future SVC standard. The first function of an SEI message is to assist the processes of decoding, display or other. However, these messages are not mandatory and a decoder in accordance with the specification should decode the video sequences without these messages. The variants provided here require the coder to have the possibility of interpreting the SEI message in question, and may execute the spatial scalability function object of the present invention. It is to be noted that the use of SEI messages has the advantage, at the date of the present invention, of not necessitating syntax modification of the decoder.

FIG. 3 illustrates steps of implementation in the particular embodiments of the decoding method object of the present invention, in particular to decode the information transmitted after carrying out the succession of steps of FIG. 2.

During a step 310, a selection is made of the definition chosen from those that are available, that is to say those which have been transmitted. This selecting step may be carried out manually, by a user using, for example, the keyboard 110 illustrated in FIG. 1, or automatically according to the characteristics of the display system.

Next, during a step 320, the information is read that represents the rate-distortion relationships associated, during step 270, with the information representing images, for example in the form of an SEI message.

Next, during a step 330, the decoding of the lower layer which serves for the prediction for the higher layer is carried out.

Next the decoding of the higher layer is executed, during a step 340. The decoding of the higher layer is carried out according to the choice of definition made during step 310. More particularly, the selection of the definition and of the rate having been carried out, the decoder knows the quantity of data to decode, by virtue of the rate-distortion information for the selected definition. According to the FGS or CGS mode used on coding, two decoding modes are possible.

in the case in which the CGS mode has been used during coding, the decoder entirely decodes a specific number of layers corresponding to the rate chosen for the selected definition.

in the case in which the FGS has been used during coding, the decoder only decodes (after truncation of the bitstream) the part of the FGS layer corresponding to the rate chosen for the selected definition.

During a step 350, the definitions of the images of the higher layer are reduced in order to provide the definitions corresponding to the definition ratio multiplied by the definitions of the lower layer. It is to be recalled that the images of the higher layer have horizontal and vertical definitions that are twice those of the lower layer in the preferred embodiment. Step 350 generates images of which the definitions correspond to the needs of the user with an optimum rate with respect to the selected definition. In practice, step 350 is carried out using downsampling filters that are well known to the person skilled in the art.

Next, during a step 360, the downsampled images are displayed resulting from step 350 and corresponding to the definitions selected by the user.

It is to be noted that the steps of decoding the lower layer and the higher layer are not made entirely one after the other as at coding. The processing operations are made by Group Of Pictures or GOP. Thus, as soon as a Group Of Pictures is decoded for the lower layer, the higher layer can be decoded. The following group is then proceeded to for the lower layer, and so forth.

On reading the above description, it can be understood that the implementation of the present invention makes it possible to pass very rapidly from one definition to another. If the system (or the user) wishes to pass to a higher definition during viewing of a sequence, it suffices for the decoder to decode a little more coded data as indicated by the information (table or model) on rate-distortion (for an equivalent quality, the higher the definition, the higher the rate).

FIG. 4 represents the results obtained by comparing the ESS method provided in the SVC standard and that provided here by the invention.

The two curves represented in FIG. 4 illustrate the performance in terms of distortion (here expressed in the form of PSNR) according to rate. They show the results of the higher layer for the ESS technique, curve 405, and those resulting from the implementation of the present invention, curve 410.

In the example of FIG. 4, the definition of the images of the sequence of the lower layer is equal to 336×288. According to the invention, the definition of the images of the coded video sequence is double, i.e. 672×576. The definition ratio selected between the lower layer and the higher layer is here 5/3. Consequently, the definition of the video sequence that is decoded, then downsampled from the higher layer is thus easily deduced: 560×480.

It is to be recalled that, by using the ESS technology of the SVC standard, the definition of the images coded for the higher layer is that corresponding to the downsampled decoded version obtained by the implementation of the present invention.

It is to be noted that the implementation of the present invention reduces the distortion of the decoded image, with respect to the initial image, whatever the rate use, starting with a minimum rate.

The scope of the present invention is not limited to the embodiments described and represented but, quite to the contrary, extends to the methods and devices as defined in the claims.

In particular, the present invention applies equally to the case in which the higher layer represents the same image part as each higher layer, for example the entirety of an image, and to the cases in which the different layers represent different parts of the same image.

1. A method of coding a digital image, comprising a step of coding in a format comprising a lower definition layer and at least one higher definition layer, characterized in that it further comprises:
a step of determining at least one data rate and/or at least one distortion corresponding to a target definition between the lower definition and a higher definition,
a step of associating, with the result of the coding step, information representing at least one data rate and/or at least one distortion corresponding to a target definition.

2. A method according to claim 1, characterized in that, during the associating step, association is made with the result of the coding step of information representing at least one target definition and at least one said rate corresponding to said target definition, at one physical quantity at least.

3. A method according to claim 2, characterized in that said physical quantity is a decoded image distortion produced by down sampling a decoded higher layer, to obtain the image having the target definition.

4. A method according to any one of claims 1 to 3, characterized in that, during the determining step, determination is made, for at least one target definition, of a plurality of rates corresponding to a plurality of decoded image distortions and, during the associating step, an item of information representing said rates and said distortions is associated with the result of the coding step.

5. A method according to any one of claims 1 to 3, characterized in that, during the determining step, determination is made, for at least one target definition, of the parameter values of a decoded image rate model on the basis of a distortion of said decoded image, and, during the associating step, an item of information representing said parameter values is associated with the result of the coding step.

6. A method according to any one of claims 1 to 3, characterized in that, during the determining step, determination is made, for at least one target definition, of the rate-distortion pairs and, during the associating step, an item of information representing said pairs is associated with the result of the coding step.

7. A method according to any one of claims 1 to 3, characterized in that the determining step comprises a step of selecting at least one said target definition.

8. A method according to any one of claims 1 to 3, characterized in that, during the coding step, SVC scalable video coding is implemented.

9. A method according to any one of claims 1 to 3, characterized in that, during the coding step, each higher definition is an integer multiple of the lower definition.

10. A coding method according to any one of claims 1 to 3, characterized in that, during the coding step, at least two higher layers are coded, the ratio between the image definitions of the higher layers being, in each dimension of the image, an integer number, at least one of the higher layers being coded by using another higher layer.

11. A coding method according to any one of claims 1 to 3, characterized in that it further comprises a step of associating, with the result of the coding step, an item of information representing the necessity, on decoding, of performing a down sampling step.

12. A coding method according to any one of claims 1 to 3, characterized in that it further comprises a step of determining a number of higher layers to code, on the basis of at least one target definition.

13. A coding method according to any one of claims 1 to 3, characterized in that it further comprises a step of determining an integer ratio between the definitions of two layers, on the basis of at least one target definition.

14. A method of decoding a digital image coded in a format comprising at least one lower definition layer and at least one higher definition layer, to form an image having a display definition, characterized in that it comprises:
a step of obtaining an item of information representing at least one data rate and/or at least one distortion, for at least one target definition, between the lower definition and a higher definition,
a step of determining a decoding rate, on the basis of the display definition and said item of information representing at least one data rate and/or at least one distortion, for a target definition,
a step of decoding a set of data of a higher layer of higher definition than the display definition, said set of data corresponding to the decoding rate determined during the determining step, to provide a decoded image having said higher definition,
a step of downsampling said decoded image to provide the image having said display definition.

15. A method according to claim 14, characterized in that, during the obtainment step, information is obtained representing at least one rate corresponding to said target definition and to a decoded image distortion.

16. A method according to any one of claims 14 or 15, characterized in that, during the obtainment step, for at least one target definition, there is obtained a plurality of rates corresponding to a plurality of decoded image distortions.

17. A method according to any one of claims 14 or 15, characterized in that, during the obtainment step, for at one least one target definition, parameter values are obtained of a decoded image rate model on the basis of a distortion of said decoded image.

18. A method according to any one of claims 14 or 15, characterized in that, during the obtainment step, for at least one target definition, rate-distortion pairs are obtained.

19. A method according to any one of claims 14 or 15, characterized in that it further comprises:
a step of determining the display definition, during which the display definition is determined as being equal to that of a display screen and
a display step, during which the downsampled image having said display definition is displayed on said display screen.

20. A device for coding a digital image, comprising a means for coding in a format comprising a lower definition layer and at least one higher definition layer, characterized in that it further comprises:
a means for determining at least one data rate and/or at least one distortion corresponding to a target definition between the lower definition and a higher definition and
a means for associating, with the result of the coding, information representing at least one data rate and/or at least one distortion corresponding to a target definition.

21. A device according to claim 20, characterized in that the associating means is adapted to associate information representing at least one target definition and at least one said rate corresponding to said target definition, at one physical quantity at least, with the result of the coding step.

22. A device according to claim 21, characterized in that said physical quantity is a decoded image distortion produced by downsampling a decoded higher layer, to obtain the image having the target definition.

23. A device according to any one of claims 20 to 22, characterized in that the determining means is adapted to determine, for at least one target definition, a plurality of rates corresponding to a plurality of decoded image distortions and the associating means is adapted to associate an item of information representing said rates and said distortions with the result of the coding.

24. A device according to any one of claims 20 to 22, characterized in that the determining means is adapted to determine, for at least one target definition, parameter values of a decoded image rate model on the basis of a distortion of said decoded image, and the associating means is adapted to associate an item of information representing said parameter values with the result of the coding.

25. A device according to any one of claims 20 to 22, characterized in that the determining means is adapted to determine, for at least one target definition, rate-distortion pairs and the associating means is adapted to associate an item of information representing said pairs with the result of the coding.

26. A device according to any one of claims 20 to 22, characterized in that the determining means comprises a means for selecting at least one said target definition.

27. A device according to claim 26, characterized in that the selecting means is adapted for a user to select at least one said target definition.

28. A device according to any one of claims 20 to 22, characterized in that the coding means implements SVC scalable video coding.

29. A device according to any one of claims 20 to 22, characterized in that the coding means is adapted for each higher definition to be an integer multiple of the lower definition.

30. A coding device according to any one of claims 20 to 22, characterized in that it comprises a means for transmitting signals representing coded images and information representing each data rate corresponding to a target definition.

31. A coding device according to any one of claims 20 to 22, characterized in that it further comprises a means for associating with the result of the coding, an item of information representing the necessity, on decoding, of using a down sampling means.

32. A coding device according to any one of claims 20 to 22, characterized in that it further comprises a means for determining a number of higher layers to code, on the basis of at least one target definition.

33. A coding device according to any one of claims 20 to 22, characterized in that it further comprises a means for determining an integer ratio between the definitions of two layers, on the basis of at least one target definition.

34. A device for decoding a digital image coded in a format comprising at least one lower definition layer and at least one higher definition layer, to form an image having a display definition, characterized in that it comprises:
a means for obtaining an item of information representing at least one data rate and/or at least one distortion, for at least one target definition, between the lower definition and a higher definition,
a means for determining a decoding rate, on the basis of the display definition and said item of information representing at least one data rate and/or at least one distortion, for a target definition,
a means for decoding a set of data of a higher layer of higher definition than the display definition, said set of data corresponding to the decoding rate determined the determining means, to provide at least one decoded image having said higher definition,
a means for downsampling said decoded image to provide an image having said display definition.

35. A device according to claim 34, characterized in that the obtaining means is adapted to obtain information representing at least one rate corresponding to said target definition and to a decoded image distortion.

36. A device according to any one of claims 34 or 35, characterized in that the obtaining means is adapted to obtain, for at least one target definition, a plurality of rates corresponding to a plurality of decoded image distortions.

37. A device according to any one of claims 34 or 35, characterized in that the obtaining means is adapted to obtain, for at one least one target definition, parameter values of a decoded image rate model on the basis of a distortion of said decoded image.

38. A device according to any one of claims 34 or 35, characterized in that the obtaining means is adapted to obtain, for at least one target definition, rate-distortion pairs.

39. A device according to any one of claims 34 or 35, characterized in that it comprises a means for selection, by a user, of said display definition.

40. A device according to any one of claims 34 or 35, characterized in that it further comprises:
a means for determining the display definition as equal to that of a display screen and
a display means adapted to display the downsampled image having said display definition on said display screen.

41. A device according to any one of claims 34 or 35, characterized in that the decoding means implements SVC scalable video decoding.

42. (canceled)

43. A computer program that can be loaded into a computer system, said program containing instructions enabling the implementation of the coding method according to any one of claims 1 to 3, when that program is loaded and executed by a computer system.

44. A computer program that can be loaded into a computer system, said program containing instructions enabling the implementation of the decoding method according to any one of claims 14 or 15, when that program is loaded and executed by a computer system.

45. A removable or non-removable carrier for computer or microprocessor readable information, storing instructions of a computer program, characterized in that it makes it possible to implement the coding method according to any one of claims 1 to 3.

46. A removable or non-removable carrier for computer or microprocessor readable information, storing instructions of a computer program, characterized in that it makes it possible to implement the decoding method according to any one of claims 14 or 15.
